(19) United States
(12) Patent Application Publication
(10) Pub. No.: US 2004/0251813 A1
(43) Pub. Date: Dec. 16, 2004

(54) Emissive flat panel display device

(76) Inventors: Makoto Okai, Tokorozawa (JP); Takahiko Muneyoshi, Musashimurayama (JP); Tomio Yaguchi, Sagamihara (JP); Nobuaki Hayashi, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/864,636

(22) Filed: Jun. 10, 2004

(30) Foreign Application Priority Data
Jun. 11, 2003 (JP) 2003-166118

(51) Int. Cl. H01J 1/62; H01J 63/04; H01J 1/14

(52) U.S. Cl. 313/495; 313/311; 313/496; 313/497

(57) ABSTRACT

An emissive flat panel display device has an electron emission and control structure which uses carbon nanotubes or the like as electron sources and is formed using a relatively inexpensive manufacturing technique. Cathode electrodes, an insulation layer and gate electrodes are formed on a back substrate by screen printing. Insulation-layer openings are formed in the insulation layer and control apertures are formed in the gate electrodes at the same positions as the insulation-layer apertures. Inner peripheries of the control apertures are retracted from inner peripheries of the insulation-layer apertures formed in the insulation layer, thus preventing sagging of a silver paste for gate electrodes into the insulation-layer apertures in a step for forming the gate electrodes. Ink containing carbon nanotubes is applied to the control apertures formed in the gate electrodes by an ink jet method or the like.

### BACKGROUND OF THE INVENTION

The present invention relates to a display device of the type which utilizes an emission of electrons into a vacuum; and, more particularly, the invention relates to an emissive flat panel display device including a back panel which is provided with cathode electrodes having electron sources and gate electrodes which control the quantity of electrons emitted from the electron sources and a face panel which is provided with phosphor layers consisting of a plurality of colors which emit light upon excitation of electrons taken out from the back panel and anode electrodes.

As a display device which exhibits high brightness and high definition, color cathode ray tubes have been popularly used conventionally over the years. However, with the recent demand for production of higher quality images in information processing equipment or television broadcasting, the demand for planar display devices which are light in weight and require a small space, while exhibiting high brightness and high definition, has been increasing.

As typical examples, liquid crystal display devices, plasma display devices and the like have been put into general use. Further, more particularly, as display devices which can realize higher brightness, it is expected that various kinds of panel-type display devices, including an electron emission type display device which utilizes an emission of electrons from electron sources into a vacuum, a field emission type display device and an organic EL display which is characterized by low power consumption, will be commercialized soon. Here, the plasma display device, the electron emission type display device or the organic EL display which requires no auxiliary illumination light source will be referred to as a self-luminous flat panel display device or an emissive flat panel display device.

Among flat panel display devices, such as the above-mentioned field emission type display device, a display device having a cone-shaped electron emission structure which was developed by C. A. Spindt et al., a display device having an electron emission structure of a metal-insulator-metal (MIM) type, a display device having an electron emission structure which utilizes an electron emission phenomenon based on a quantum theory tunneling effect (also referred to as “a surface conduction type electron source), and a display device which utilizes an electron emission phenomenon, which a diamond film, a graphite film and a nanotube structure represented by carbon nanotubes and the like possesses, have been known.

The field emission type display device, which is one example of emissive flat panel display device, is constituted by sealing a back panel, on which field-emission-type electron sources and gate electrodes which constitute control electrodes are formed on an inner surface thereof, and a face panel, which includes phosphor layers consisting of a plurality of colors and an anode electrode (an anode) on an inner surface thereof, which opposingly faces the back panel, with a sealing frame being interposed between inner peripheries of both panels, and by evacuating the inside space defined by the back panel, the face panel and the sealing frame. The back panel includes a plurality of cathode lines having electron sources, which extend in a first direction and are arranged in parallel in second direction which crosses the first direction, and gate electrodes, which extend in the second direction and are arranged in parallel in the first direction, on the back substrate, which is preferably made of glass, alumina or the like. Then, in response to a potential difference applied between the cathode electrode and the gate electrode, an emission quantity (including ON and OFF) of electrons emitted from the electron sources is controlled.

Further, the face panel includes phosphor layers and an anode electrode disposed on the face substrate, which is formed of a light transmitting material, such as glass or the like. The sealing frame is fixedly adhered to inner peripheries of the back panel and the face panel using an adhesive material, such as frit glass. The degree of vacuum in the inside space defined by the back panel, the face panel and the sealing frame is, for example, 10⁻⁵ to 10⁻⁷ Torr. When the field emission type display device has a large-sized display screen, both panels are fixed to each other by interposing gap holding members (spacers) between the back panel and the face panel, thus holding the gap between both substrates to a given distance.

Here, as an example of literature which discloses an emissive flat panel display device which utilizes carbon nanotubes, which are a typical example of nanotubes used as electron sources, JP-A-2001-43791 and JP-T-2002-508110 are cited. Further, with respect to an emissive flat panel display device which uses a photolithography process, many written articles are available, including “Eurodisplay 2002 Digest, pp. 229-231” (paper 12-4).

### SUMMARY OF THE INVENTION

As a technique which forms electron sources, such as carbon nanotubes, and an electron emission and control structure, such as gate electrodes, on the back substrate which constitutes the same substrate used for the electron sources and the above-mentioned structure, a photolithography process is generally used. However, this method requires a large-scale and expensive exposure device, and, hence, the manufacturing cost is increased.

Accordingly, it is an object of the present invention to realize an electron emissive flat panel display device having an electron emission and control structure which utilizes carbon nanotubes as electron sources using a relatively inexpensive manufacturing technique.

To achieve the above-mentioned object, the present invention provides a low-cost electron emissive flat panel display device which is obtained by forming the whole or a major portion of the electron emission and control structure using a printing method, such as a screen printing method.

That is, according to the present invention, an electron emissive flat panel display device includes a back panel on which a plurality of cathode electrodes having a large number of electron sources are formed to extend in a first direction and are arranged in parallel in a second direction which intersects the first direction, and a plurality of gate electrodes are formed to extend thereon in the second direction and are arranged in parallel in the first direction with respect to the cathode electrodes by way of an insulation layer so as to control the takeout of electrons from the electron sources. The electron emissive flat panel display device also includes a face panel on which a plurality of phosphor layers of a plurality of colors are formed to emit light upon excitation by the electrons taken out from the back panel, and an anode electrode is formed thereon.

The cathode electrodes which are formed on the back panel, the insulation layer which is formed above the cathode electrodes and has apertures at positions corresponding to the electron sources formed on the cathode electrodes, and the gate electrodes which are formed on the insulation layer and have control apertures for controlling the takeout of electrons at portions corresponding to the apertures formed in the insulation layer are formed by printing.

Further, according to the present invention, the inner peripheries of the control apertures formed in the gate electrodes may be arranged at positions recessed from the inner peripheries of the apertures formed in the insulation layer. The electron sources may be formed of nanotubes which are formed by an ink jet method in which ink containing the nanotubes is injected through the control apertures formed in the gate electrode and the apertures formed in the insulation layer, or by a vapor-phase growth method which is performed through the control apertures formed in the gate electrode and the apertures formed in the insulation layer.

Further, according to the present invention, an emissive flat panel display device includes a back panel on which a plurality of gate electrodes are formed to extend in a first direction and are arranged in parallel in a second direction, which intersects the first direction and a plurality of cathode electrodes having a large number of electron sources are formed to extend thereon in the second direction and are arranged in parallel in the first direction with respect to the gate electrodes by way of an insulation layer. The electron emissive flat panel display device also includes a face panel which has phosphor layers a plurality of colors which emit light upon excitation by electrons taken out from the back panel, and an anode electrode is formed thereon.

The gate electrodes are constituted of lower gate electrodes and upper gate electrodes which are formed on the back substrate, and the insulation layer is formed on the lower gate electrodes while having apertures which allow an electric connection to be established between the lower gate electrodes and the upper gate electrodes.

The upper gate electrodes are formed to be discontinuously aligned on the insulation layer in the first direction and the second direction, and, at the same time, the respective discontinuously formed upper gate electrodes are connected with the lower gate electrodes through the apertures formed in the insulation layer, the cathode electrodes are formed in the second direction between the apertures on the insulation layer, the electron sources are formed between the upper electrodes which are arranged in the first direction on the cathode electrodes, and the lower gate electrodes, the insulation layer, the upper gate electrodes and the cathode electrodes are formed by a printing method.

Further, according to the present invention, the upper gate electrodes and the cathode electrodes may be formed on the same plane which is parallel to a surface of the back substrate, and the electron sources may be formed by printing using ink which contains nanotubes, or using nanotubes formed by a vapor-phase growth method or by an ink jet method which injects ink which contains nanotubes.

The present invention is not limited to the above-mentioned constitutions and the constitutions which form the embodiments described later, and various modifications are conceivable without departing from the technical concept of the present invention.

### BRIEF DESCRIPTION OF THE DRAWINGS

FIG. 1 is an exploded perspective view as seen from a position obliquely above the electron emissive flat panel display device of the present invention, showing the overall constitution of the display device in a developed form;

FIG. 2 is an exploded perspective view as seen from a position obliquely below the electron emissive flat panel display device shown in FIG. 1, illustrating the overall constitution of the display device in a developed form;

FIG. 3(a) is a schematic diagram showing a top plan view of a back panel which constitutes the electron emissive flat panel display device of the present invention, and FIG. 3(b) is a diagram showing the details of area A in FIG. 3(a);

FIG. 4(a) is a diagram showing a plan view of a front panel which constitutes the emissive flat panel display device of the present invention, and FIG. 4(b) is a diagram showing the details of area B in FIG. 4(a);

FIG. 5 is a perspective view showing a step in the manufacture of the first embodiment of the emissive flat panel display device according to the present invention;

FIG. 6 is a perspective view showing a manufacturing step which follows the manufacturing step shown in FIG. 5;

FIG. 7 is a perspective view showing a manufacturing step which follows the manufacturing step shown in FIG. 6;

FIG. 8 is a perspective view showing a manufacturing step which follows the manufacturing step shown in FIG. 7;

FIG. 9 is a perspective view showing a step in the manufacture of a second embodiment of the emissive flat panel display device according to the present invention and the structure thereof;

FIG. 10 is a perspective view showing a manufacturing step which follows the manufacturing step shown in FIG. 9;

FIG. 11 is a perspective view showing a manufacturing step which follows the manufacturing step shown in FIG. 10;

FIG. 12 is a perspective view showing a manufacturing step which follows the manufacturing step shown in FIG. 11; and

FIG. 13 is a perspective view showing a step in the manufacture of the third embodiment of the emissive flat panel display device according to the present invention and the structure thereof.

### DESCRIPTION OF THE PREFERRED EMBODIMENTS

Embodiments of the present invention will be explained in detail in conjunction with the drawings.

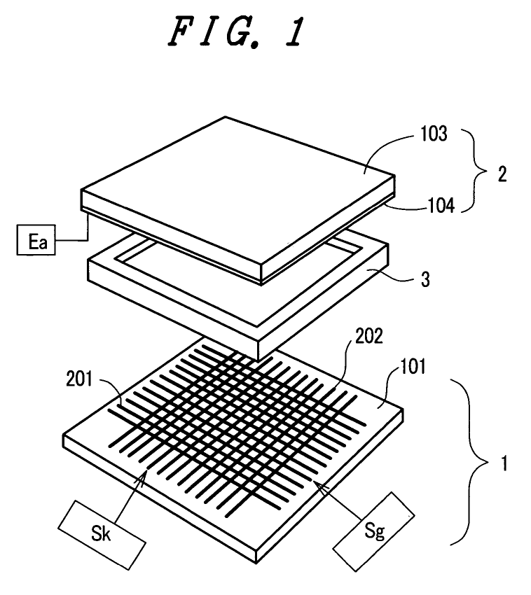

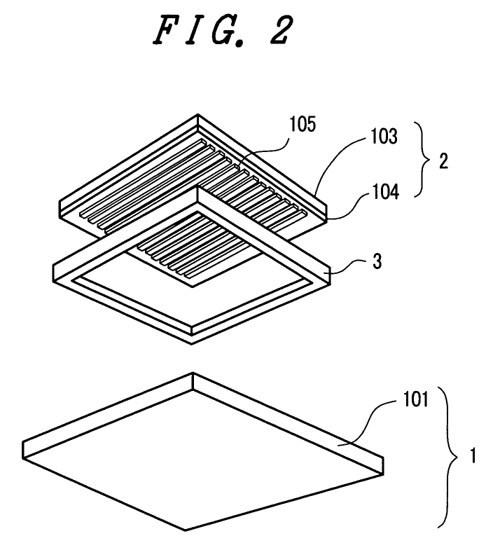

In FIG. 1 and FIG. 2, the emissive flat panel display device is formed of an integral assembled body constituted of a back panel 1, which is preferably made of glass, and a face panel 2, which are joined and sealed using a sealing frame 3. The back panel 1 includes, as an electron emission and control structure, a large number of cathode electrodes 202, which extend in a first direction (for example, the vertical direction) and are arranged in parallel in a second direction (for example, the horizontal direction) which intersects the first direction, and a large number of gate electrodes 201, which extend in the second direction and are arranged in parallel in the first direction, on an inner surface of a back substrate 101. A video signal Sk is applied to the cathode electrodes 202, and a selection signal Sg is applied to the gate electrodes 201.

To an inner surface of a face substrate 103 which constitutes the face panel 2, a plurality of phosphors (here, phosphors consisting of the three colors of red (R), green (G), blue (B)) are applied in the first direction in a stripe shape, and an anode electrode 104, which is in the form of an aluminum film having a film thickness of several tens to several hundreds nm, is formed thereon by vapor deposition as a transparent conductive film on the entire surface of the phosphors. An acceleration voltage Ea is applied to the anode electrode 104. The phosphors are not limited to a stripe shape as shown in the drawing and may be formed in dot shapes for the respective colors. Here, the sealing frame 3 has a function of holding the inside space, formed by laminating the back panel 1 and the face panel 2, in a vacuum state and, at the same time, a function of maintaining a gap between opposing, facing surfaces at a given value. Further, when the screen size is large, the gap defined between the opposing, facing surfaces can be held at a given value by interposing spacers inside the sealing frame 3 and between both panels. The sealing frame 3 and the spacers are also preferably formed of glass.

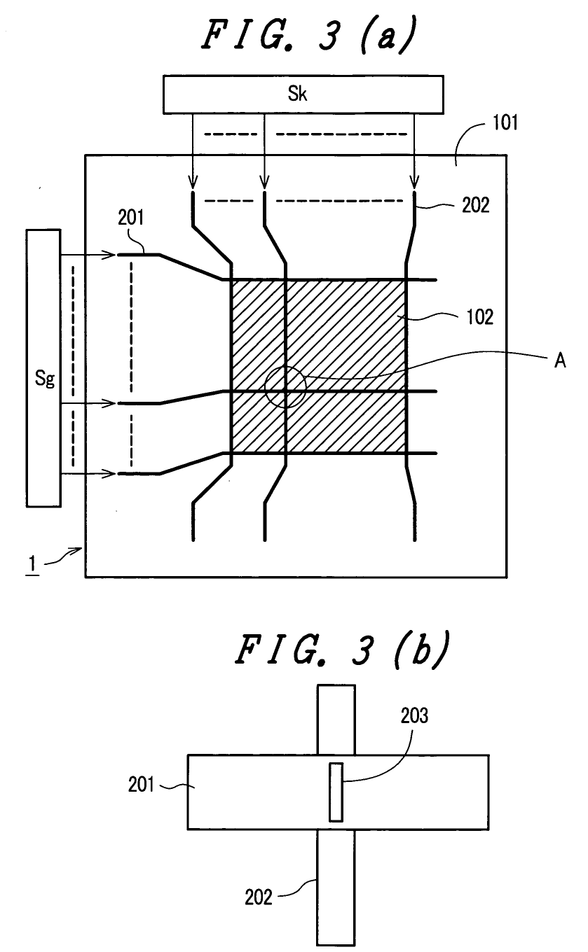

FIG. 3(a) and FIG. 3(b) are diagrams which show an example of the back panel 1 which constitutes the emissive flat panel display device of the present invention, wherein FIG. 3(a) is a plan view and FIG. 3B is a view showing the constitution of one representative pixel which appears in part A in FIG. 3(a). In a display region of the back substrate 101, the above-mentioned cathode electrodes 202 and gate electrodes 201 are arranged in a matrix array. The cathode electrodes 202 and the gate electrodes 201 are electrically insulated from each other by an insulation layer (not shown in the drawing), and electron sources (here, carbon nanotubes) 203 are provided at respective intersecting portions, as shown in FIG. 3(b). The electron sources 203 are formed on the cathode electrodes 202 and are exposed from control apertures (to be described later) that are formed in the gate electrodes 201.

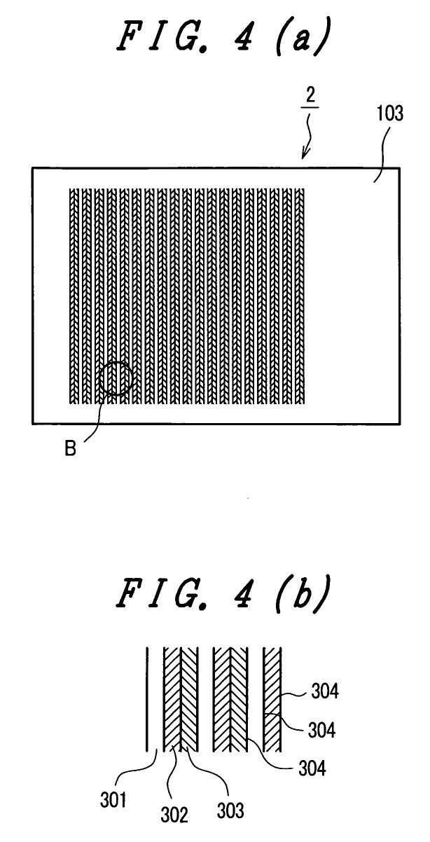

FIG. 4(a) and FIG. 4(b) are diagrams which show an example of the face panel 2 which constitutes the emissive flat panel display device of the present invention, wherein FIG. 4(a) is a plan view and a FIG. 4(b) is a view showing an example of the phosphor arrangement as seen in area B in FIG. 4(a). Here, although an anode electrode is formed on the upper surfaces of the phosphors, the anode electrode is omitted from the drawing. The face panel 2 forms a video observation surface, and the face substrate 103 is preferably made of glass. To an inner surface of the face substrate 103, the phosphors 301, 302, 303 of three colors which are repeatedly arranged in a stripe shape are provided, and a light shielding layer, that is, a black matrix 304 is arranged on the boundaries among the respective phosphors 301, 302, 303. The respective phosphors 301, 302, 303 are arranged to face the respective electron sources in an opposed manner. The phosphor layer, which is constituted of the phosphors 301, 302, 303 and the black matrix 304, is formed in a following manner.

First of all, the black matrix 304 is formed on the face substrate 103 by a known lift-off method. Next, using a known slurry method in the same manner, the phosphors of three colors consisting of red (R), green (G) and blue (B) are sequentially formed such that the respective phosphors are defined by the black matrix 304. Then, the anode electrode is formed to cover the phosphors.

The electron sources and the phosphors formed on the front panel 2, which is manufactured in the above-mentioned manner, are positioned with respect to the back panel 1, and, thereafter, the face panel 2 and the back panel 1 are overlapped relative to each other by way of the sealing frame 3 and are adhered to each other using frit glass. The frit glass is applied to any one or both of the respective opposingly facing surfaces of the face panel 2, the back panel 1 and the sealing frame 3 by coating, is heated at a temperature of 450° C., and is cured or hardened by lowering of the temperature. After evacuating the inner space defined by both panels and the sealing frame using an exhaust pipe (not shown in the drawing), thus creating a vacuum in the inner space, the exhaust pipe is sealed. It is desirable that the exhaust pipe is formed on a portion of the back substrate 101 or a portion of the sealing frame 3. Then, by applying a video signal to the cathode electrodes, a scanning signal to the gate electrodes, and an anode voltage (a high voltage) to the anode electrode, it is possible to make the emissive flat panel display device display a desired video image.

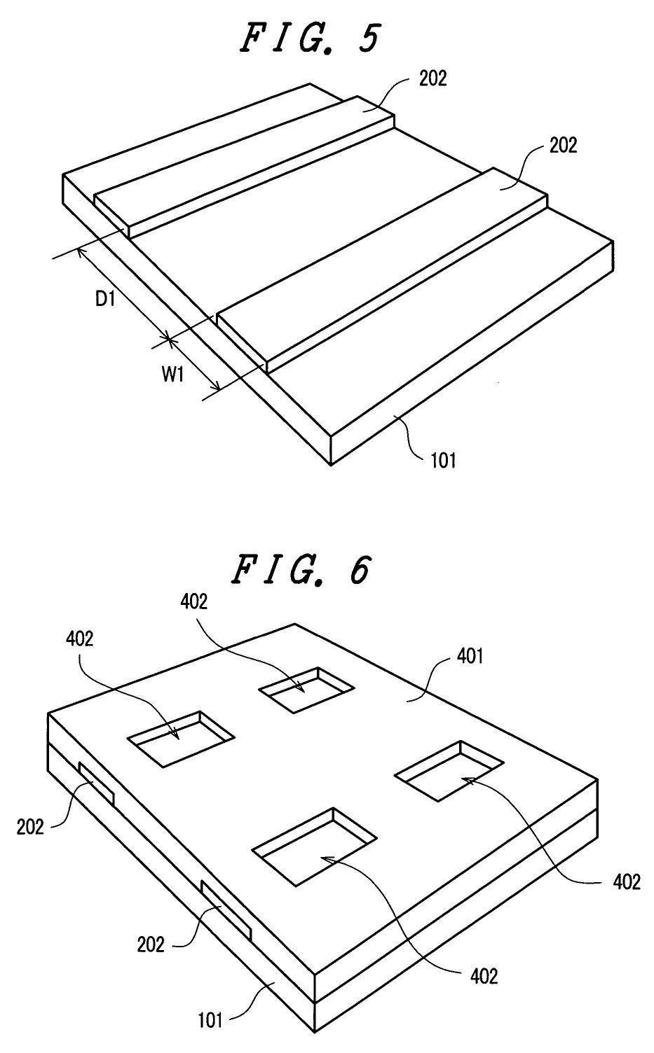

FIG. 5 to FIG. 8 are diagram which show manufacturing steps in the fabrication of the first embodiment of the emissive flat panel display device according to the present invention and the structure thereof. In the first embodiment of the emissive flat panel display device of the present invention, a type of device in which the gate electrodes are positioned closer to the anode electrode side than the cathode electrodes is adopted. Here, 4×4 pixels (four sub pixels, the sub pixel indicating a unit color pixel) in the display region will be considered hereinafter. First of all, as shown in FIG. 5, the cathode electrodes 202 are printed in a stripe shape on the back substrate 101 by a screen printing method. Here, a width W1 of the stripe is 100 μm and the distance D1 is 100 μm so that, for example, 1280×3 cathode electrodes are formed. Baking is performed after printing. The cathode electrodes 202 are formed using a silver paste, and the film thickness of the cathode electrode 202 is set to be 5 μm after baking.

Next, as shown in FIG. 6, an insulation layer 401 is formed by screen printing so that it covers the cathode electrodes 202. The insulation layer 401 is printed so as to include apertures (insulation layer apertures) 402, through which the cathode electrodes 202 arranged below the insulation layer 401 are exposed for respective sub pixels, and the insulation layer 401 is baked. The film thickness of the insulation layer 401 is set to be 10 μm after baking.

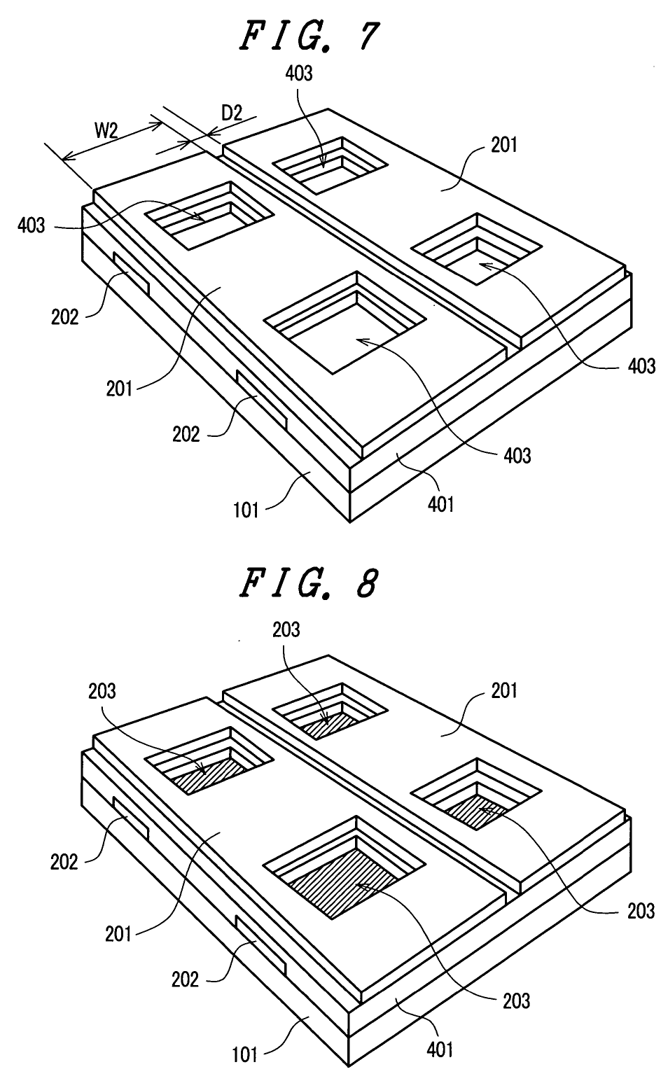

In FIG. 7, the gate electrodes 201 are formed in a stripe shape in the direction which intersects the cathode electrodes 202 by screen printing, and thereafter, they are baked. Control apertures 403 are formed in the gate electrode 201 so as to open at the same position as the insulation-layer apertures 402 formed in the insulation layer 401. Further, the inner periphery of the control aperture 403 is retracted from an inner periphery of the aperture 402 formed in the insulation layer 401 so as to increase the aperture area thereof, and, hence, in a step of forming the gate electrode 201, it is possible to prevent the silver paste used for the gate electrode from sagging into the aperture 402 of the insulation layer 401. The width W2 of the gate electrode 201 is 700 μm, and the distance D2 is 100 μm. Further, the film thickness of the gate electrode 201 is set to be 5 μm after baking. Here, 720 gate electrodes 201 are formed.

Next, as shown in FIG. 8, ink 203 containing carbon nanotubes is applied to the control apertures 403 formed in the gate electrodes 201 by an ink jet method. The ink contains the carbon nanotubes and an organic solvent, and the organic solvent is dissipated due to baking at a relatively low temperature. Further, to obtain a favorable electrical connection between the carbon nanotubes and the cathode electrode, a suitable amount of metal particles may be contained in the ink.

As described above, by using the screen printing method and the ink jet method, it is possible to form the electron emission and control structure, which is constituted of the cathode electrodes having electron sources and gate electrodes which control the emission of electrons from the electron sources on the back substrate 101. Further, in this embodiment, although baking is performed for the printing of every layer, the layer containing the carbon nanotubes is baked after forming the constitutional layers other than the layer which contains the carbon nanotubes, and the layer containing the carbon nanotubes is again baked at a relatively low temperature after applying the carbon nanotubes. Further, although the cathode electrodes and the gate electrodes are formed using silver paste in this embodiment, the material of the cathode electrodes and the gate electrodes is not limited to silver paste, and a metal, alloy or a multilayered film having the required electrical conductive ability can be adopted.

In this embodiment, although the electron sources formed of carbon nanotubes are applied by the ink jet method, in place of this ink jet method, the electron sources may be formed by a plasma CVD method, which uses a hydrocarbon gas as a raw material, or by a vapor-phase growth method, such as a thermal CVD method. Still further, as the carbon nanotubes, a single wall structure, a multi-wall structure or a mixture of these structures may be used. Still further, nanotubes which are made of a material other than carbon also may be used.

By combining the back panel as manufactured in accordance with this embodiment with the above-mentioned face panel, it is possible to obtain an emissive flat panel display device which can produce a favorable image display.

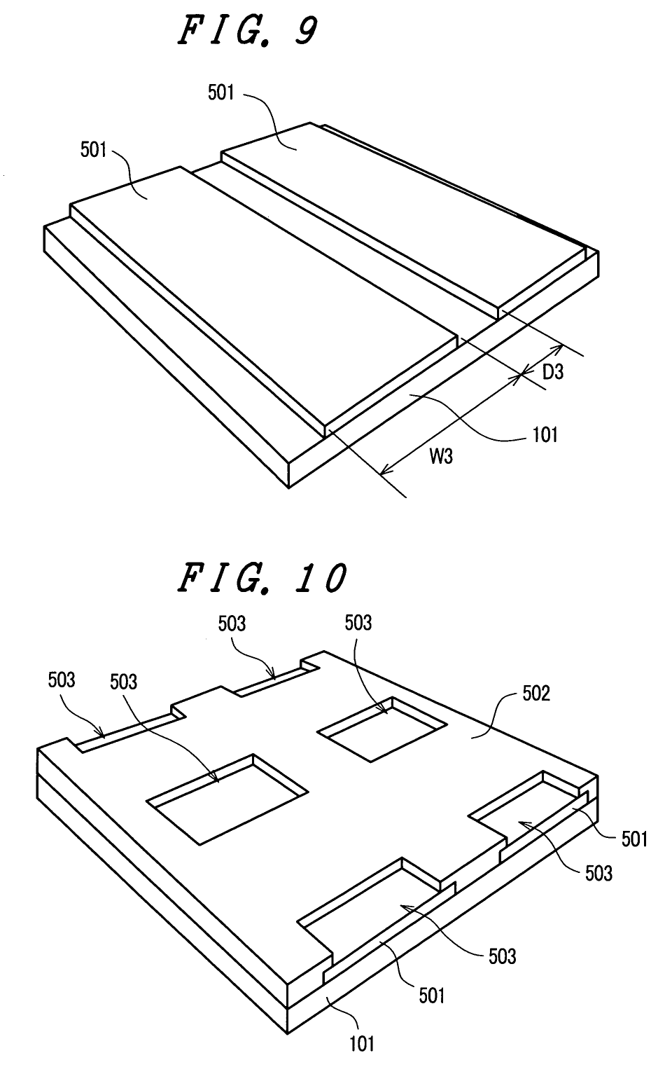

FIG. 9 to FIG. 12 are diagrams which show the manufacturing steps used in the fabrication of a second embodiment of the emissive flat panel display device according to the present invention and the structure thereof. The second embodiment of the emissive flat panel display device of the present invention is of a type in which the gate electrodes and cathode electrodes are formed on the same surface parallel to the back substrate. First of all, as shown in FIG. 9, lower gate electrodes 501 are formed on the back substrate 101, which is preferably made of glass, by screen printing, and then they are baked. The width W3 of the lower gate electrode 501 is 700 μm and the distance D3 between the lower gate electrodes 501 is 100 μm. The material of the lower gate electrode 501 is a silver paste, and the lower gate electrode 501 is assumed to have a film thickness of 5 μm after baking. Here, the number of lower gate electrodes 501 is 720.

Next, as shown in FIG. 10, an insulation layer 502 is applied by screen printing so that it covers the lower gate electrodes 501, and, thereafter, the insulation layer 502 is baked. In the insulation layer 502, insulation-layer apertures 503 are formed at portions close to sub pixel portions of the lower gate electrodes 501 so as to expose the lower gate electrodes 501 through the insulation-layer apertures 503. The thickness of the insulation layer 502 is assumed to be 10 μm after baking.

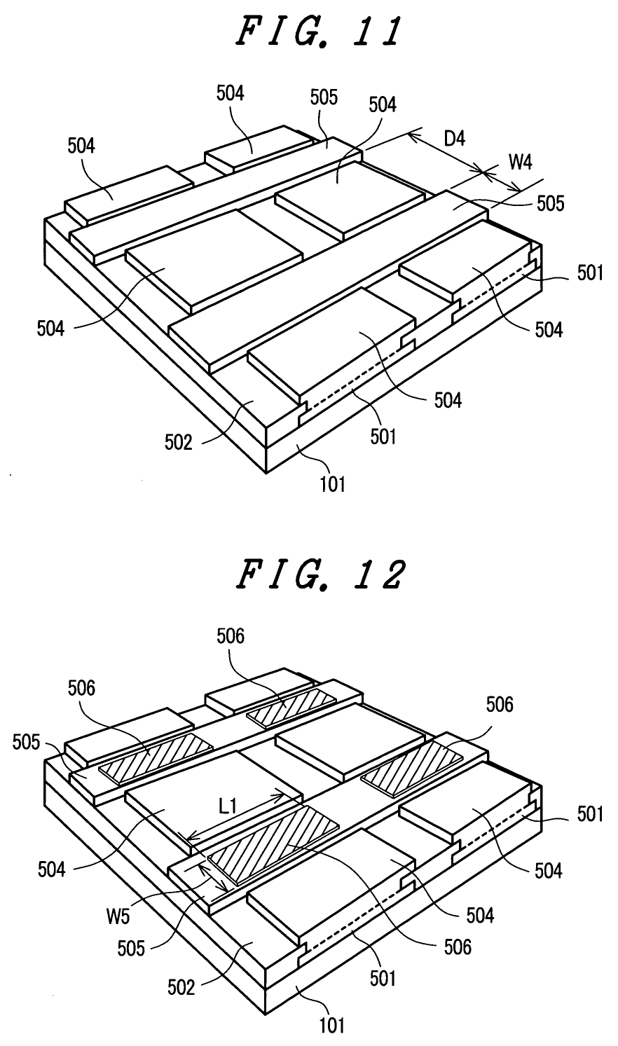

In FIG. 11, the upper gate electrodes 504 and the cathode electrodes 505 are simultaneously formed by screen printing, and, thereafter, they are baked. Each upper gate electrode 504 is applied over an area larger than the area of the insulation-layer aperture 503 that is formed in the insulation layer 502. The upper gate electrode 504 is electrically connected with the lower gate electrode 501 through the insulation-layer aperture. Both of the upper gate electrodes 504 and the cathode electrodes 505 are made of a silver paste, wherein the film thickness of the upper gate electrodes is set to be 5 μm after baking. The width W4 of the cathode electrode 505 is 100 μm, the distance D4 between the cathode electrodes 505 is 100 μm, and the film thickness of the cathode electrode 505 is assumed to be 5 μm after baking. The number of these cathode electrodes 505 is 1280×3 in this embodiment.

Next, as shown in FIG. 12, a paste containing carbon nanotubes is applied to the cathode electrodes 505 by a screen printing method, and the paste is baked to form electron sources 506. The width W5 of the carbon nanotubes is narrower than the width of the cathode electrode 505, and the length L1 of the carbon nanotubes is shorter than the length of the upper gate electrode 504 that is arranged close to the carbon nanotubes.

By combining the back panel which is manufactured in accordance with this embodiment and the previously-mentioned face panel, it is possible to obtain an emissive flat panel display device which is capable of producing a favorable image display. Here, in the above-mentioned manufacturing process, although baking after applying (coating) is performed after the application of each layer, baking may be performed after forming the constitutional layers other than the carbon nanotubes, and baking may be performed again at a relatively low temperature after applying the carbon nanotubes. Further, in this embodiment, although the carbon nanotubes are applied by screen printing, in place of this screen printing, the electron sources may be formed by a plasma CVD method, which uses a hydrocarbon gas as a raw material, or by a vapor-phase growth method, such as a thermal CVD method. Further, as the carbon nanotubes, a single wall structure, a multi-wall structure or a mixture of these structures may be used. Still further, nanotubes which are made of a material other than carbon also may be used.

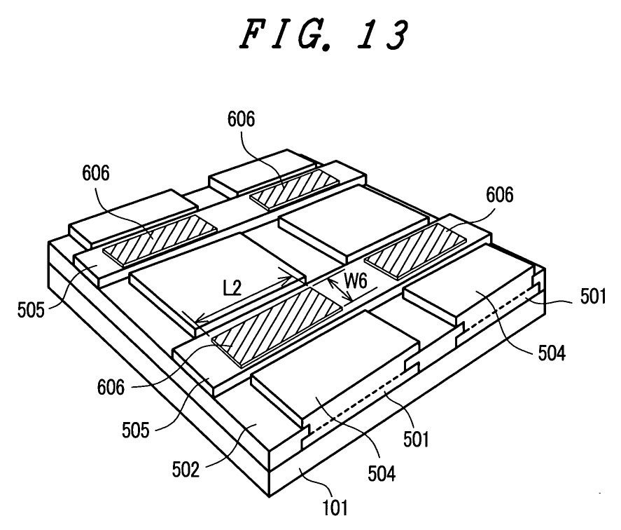

FIG. 13 is a diagram which shows manufacturing steps used in the fabrication of a third embodiment of an emissive flat panel display device according to the present invention and the structure thereof. The manufacturing process used for this third embodiment is the same as the manufacturing process explained in connection with the second embodiment with reference FIG. 9 to FIG. 11, except for the step of forming the electron sources. In this embodiment, onto the cathode electrodes 505 that are obtained by the process explained in conjunction with FIG. 11, ink containing carbon nanotubes is applied by an ink jet method, thus forming electron sources 606. The width W6 of the carbon nanotubes 606 is smaller than the width of the cathode electrode 505, and the length L2 of the carbon nanotube is smaller than the length of the upper gate electrodes 504.

The ink applied by the ink jet method contains carbon nanotubes and an organic solvent, and the organic solvent is dissipated by baking at a relatively low temperature. Further, to obtain a favorable electrical connection between the carbon nanotubes and the cathode electrode, the ink may contain a suitable amount of metal particles.

By combining the back panel manufactured in accordance with this embodiment and the previously-mentioned face panel, it is possible to obtain an emissive flat panel display device which is capable of producing a favorable image display. Here, in the above-mentioned manufacturing process, baking after applying (coating) is performed after the application of each layer, although baking may be performed after forming constitutional layers other than the carbon nanotubes, and baking may be performed again at a relatively low temperature after applying the carbon nanotubes. Further, in this embodiment, although the carbon nanotubes are applied by the ink jet method, in place of this ink jet method, the electron sources may be formed by a plasma CVD method, which uses a hydrocarbon gas as a raw material, or by a vapor-phase growth method, such as a thermal CVD method. Still further, as the carbon nanotubes, a single wall structure, a multi-wall structure or a mixture of these structures may be used. Still further, nanotubes which are made of a material other than carbon also may be used.

As has been explained heretofore, according to the present invention, the major portion of the electron emission and control structure is formed on the back substrate by a printing method, and, hence, a large-scale and expensive exposure device, which is required by the conventional technique, including the photolithography method, is no longer necessary, whereby it is possible to provide an emissive flat panel display device at a low cost.

1. An emissive flat panel display device comprising:
a back panel in which a plurality of cathode electrodes are formed having a large number of electron sources which extend in a first direction and are arranged in parallel in a second direction which intersects the first direction, and a plurality of gate electrodes are formed which extend in the second direction and are arranged in parallel in the first direction with respect to the cathode electrodes by way of an insulation layer to control the takeout of electrons from the electron sources, on a back substrate thereof, and
a face panel in which a plurality of phosphor layers of a plurality of colors are formed to emit light upon excitation of the electrons taken out from the back panel and in which an anode electrode is formed, wherein
the insulation layer is formed above the cathode electrodes and has apertures located at positions of the electron sources formed on the cathode electrodes,
the gate electrodes are formed on the insulation layer and have control apertures for controlling the takeout of electrons at portions corresponding to the apertures formed in the insulation layer, and
the cathode electrodes, the insulation layer and the gate electrodes are formed by printing.

2. An emissive flat panel display device according to claim 1, wherein inner peripheries of the control apertures formed in the gate electrodes are arranged at positions retracted from inner peripheries of the apertures formed in the insulation layer.

3. An emissive flat panel display device according to claim 1, wherein the electron sources are formed by an ink jet method which injects ink including nanotubes through the control apertures formed in the gate electrode and the apertures formed in the insulation layer.

4. An emissive flat panel display device according to claim 1, wherein the electron sources include nanotubes which are formed by a vapor-phase growth method through the control apertures formed in the gate electrode and the apertures formed in the insulation layer.

5. An emissive flat panel display device comprising:
a back panel in which a plurality of gate electrodes are formed which extend in a first direction and are arranged in parallel in a second direction which intersects the first direction, and a plurality of cathode electrodes are formed having a large number of electron sources which extend in the second direction and are arranged in parallel in the first direction with respect to the gate electrodes by way of an insulation layers on a back substrate thereof, and
a face panel in which phosphor layers of a plurality of colors are formed to emit light upon excitation of electrons taken out from the back panel, and in which an anode electrode is formed,
the gate electrodes are constituted of lower gate electrodes and upper gate electrodes which are formed on the back substrate,
the insulation layer is formed on the lower gate electrodes while having apertures which allow electrical connection between the lower gate electrodes and the upper gate electrodes,
the upper gate electrodes are formed to be discontinuously aligned on the insulation layer in the first direction and the second direction, and, at the same time, the respective discontinuously formed upper gate electrodes are connected with the lower gate electrodes through the apertures formed in the insulation layer,
the cathode electrodes are formed in the second direction between the apertures on the insulation layer,
the electron sources are formed between the upper gate electrodes as viewed from the first direction and on the cathode electrodes, and
the lower gate electrodes, the insulation layer, the upper gate electrodes and the cathode electrodes are formed by a printing method.

6. An emissive flat panel display device according to claim 5, wherein the upper gate electrodes and the cathode electrodes are formed on the same plane parallel to a surface of the back substrate.

7. An emissive flat panel display device according to claim 5, wherein the electron sources are formed by printing using ink which contains nanotubes.

8. An emissive flat panel display device according to claim 5, wherein the electron sources contain nanotubes formed by a vapor-phase growth method.

9. An emissive flat panel display device according to claim 5, wherein the electron sources are formed by an ink jet method which injects ink which contains nanotubes.

10. An emissive flat panel display device according to claim 7, wherein the nanotubes are made of carbon nanotubes.
